(19) United States
(12) Patent Application Publication
(10) Pub. No.: US 2022/0004858 A1
(43) Pub. Date: Jan. 6, 2022

(54) METHOD FOR PROCESSING ARTIFICIAL NEURAL NETWORK, AND ELECTRONIC DEVICE THEREFOR

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Jonghun LEE, Suwon-si (KR); Youngsok KIM, Seoul (KR); Jangwoo KIM, Seoul (KR); Daehyun KIM, Suwon-si (KR); Myungsun KIM, Seongnam-si (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 17/478,246

(22) Filed: Sep. 17, 2021

Related U.S. Application Data
(63) Continuation of application No. PCT/KR2019/005737, filed on May 13, 2019.

(30) Foreign Application Priority Data
Mar. 20, 2019 (KR) 10-2019-0031654

(51) Int. Cl. G06N 3/063; G06N 3/04

(52) U.S. Cl. CPC G06N 3/063; G06N 3/04

(57) ABSTRACT

A method for processing an artificial network by an electronic device includes obtaining, by using a first processor and a second processor, a neural network computation plan for performing computation of a first neural network layer of the artificial neural network, performing a first portion of a computation of the first neural network layer by using the first processor, and performing a second portion of the computation of the first neural network layer by using the second processor based on the obtained neural network computation plan, obtaining a first output value based on a performance result of the first processor and a second output value based on a performance result of the second processor, and using the obtained first output value and the second output value as an input value of a second neural network layer of the artificial neural network.

### CROSS REFERENCE TO RELATED APPLICATIONS

This application is a bypass continuation of PCT Application No. PCT/KR2019/005737, which claims priority to Korean Application No. 10-2019-0031654, filed on Mar. 20, 2019, in the Korean Intellectual Property Office, the disclosure of which is incorporated by reference herein in its entirety.

### BACKGROUND

### 1. Field

The disclosure relates to a method for processing an artificial neural network and an electronic device therefor, and more particularly, to technology for performing computation of an artificial neural network.

### 2. Description of Related Art

An artificial neural network is a statistical learning algorithm which obtains a neuron structure of an animal nervous system based on a mathematical expression, and may indicate an overall model having problem solving capabilities through learning and without a specific task process and rules.

The artificial neural network may be an algorithm which is key in the field of artificial intelligence, and may be utilized in various fields such as, for example, and without limitation, voice recognition, language recognition, writing recognition, image recognition, context inference, and the like.

Recently, convolutional neural network (CNN) based deep learning algorithms are showing superior performance in fields such as computer vision and voice recognition. A convolutional neural network is a type of a forward-reverse artificial neural network, and is actively studied in various image processing which extract abstracted information. As an example, the electronic device may be configured to recognize features by dividing an input image to small zones based on the convolutional neural network, combine the divided images as the neural network step proceeds, and recognize a whole image.

In order to effectively utilize the artificial neural network described above, an improvement in performance of a neural network framework which operates the artificial neural network may be required. The neural network framework may be configured to manage an operation of resources to process the artificial neural network, a method for processing the artificial neural network, and the like.

An artificial neural network may be used in a mobile device to further enrich user experience, and provide a customized service to a user.

When using the artificial neural network in the mobile device, a significant portion of the use may be based on an external cloud resource. When using the cloud resource, the mobile device may incur the problem of data inference being delayed according to a network status, or data inference not being performed when connection with the Internet is lost. In addition, a problem of being vulnerable in user security may arise as personal data is provided to a cloud. Further, as users of cloud resource increase, a bottleneck phenomenon may occur to data inference using cloud resource.

Recently, performances of processors (e.g., System-on-Chips (SoCs)) of mobile devices are being further enhanced according to the development of technology. This makes data inference using the artificial neural network possible by using a hardware resource of the mobile device. Accordingly, operation of the neural network framework is necessary to effectively use the hardware resource of the mobile device. That is, there is a need for inference latency of the artificial neural network to be minimized.

### SUMMARY

According to an aspect of the disclosure, a method for processing an artificial network by an electronic device includes obtaining, by using a first processor and a second processor, a neural network computation plan for performing computation of a first neural network layer of the artificial neural network, performing a first portion of a computation of the first neural network layer by using the first processor, and performing a second portion of the computation of the first neural network layer by using the second processor based on the obtained neural network computation plan, obtaining a first output value based on a performance result of the first processor and a second output value based on a performance result of the second processor, and using the obtained first output value and the second output value as an input value of a second neural network layer of the artificial neural network.

According to an aspect of the disclosure, an electronic device configured to process an artificial neural network includes a memory configured to store instructions; and a plurality of processors configured to execute the instructions and including a first processor and a second processor, wherein at least one of the plurality of processors is configured to obtain a neural network computation plan for performing computation of a first neural network layer of the artificial neural network, wherein the first processor is configured to perform a first portion of the computation of the first neural network layer, and the second processor is configured to perform a second portion of the computation of the first neural network layer, based on the neural network computation plan, and wherein the at least one of the plurality of processors is further configured to use a first output value obtained based on a performance result of the first processor and a second output value obtained based on a performance result of the second processor as an input value of a second neural network layer of the artificial neural network.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to an embodiment;

FIGS. 2A and 2B are diagrams illustrating a structure of a convolutional neural network according to an embodiment;

FIGS. 3A and 3B are diagrams illustrating a process of performing computation of an artificial neural network according to an embodiment;

FIG. 4 is a diagram illustrating a configuration of a neural network framework for processing an artificial neural network according to an embodiment;

FIGS. 5A and 5B are diagrams illustrating a process of a plurality of processors distributing and performing computations of a neural network layer according to an embodiment;

FIGS. 6A and 6B are diagrams illustrating a process of a plurality of processors performing an computation of a neural network layer by using a converted data structure according to an embodiment;

FIG. 7 is a diagram illustrating a layer distributor according to an embodiment; and

FIG. 8 is a flowchart illustrating an electronic device processing an artificial neural network according to an embodiment.

### DETAILED DESCRIPTION

Various embodiments of the disclosure will be described herein with reference to the accompanying drawings. It should be noted that terms used in the various embodiments are not for limiting the technical features disclosed in the disclosure to a specific embodiment, but should be interpreted to include all modifications, equivalents and/or alternatives of the embodiments. In describing the drawings, like reference numerals may be used to refer to like or related elements. A singular noun corresponding to an item includes one or a plurality of the items, unless clearly specified according to the related context. In the disclosure, phrases such as “A or B,” “at least one of A and B,” “at least one of A or B,” “A, B or C,” “at least one of A, B and C,” and “at least one of A, B or C” may include any one of the items listed together with the relevant phrase of the phrases, or all possible combinations thereof. Terms such as “first,” “second,” “1st,” or “2nd” may be used to simply distinguish a relevant element from another relevant element and not to limit the relevant elements from a different aspect (e.g., importance or order). When a certain element (e.g., first element) is indicated as being “coupled with/to” or “connected to” another element (e.g., second element) with or without the terms “operatively” or “communicatively,” it may be understood as the certain element being directly (e.g., via wire) or wirelessly coupled with/to the another element, or as being coupled through other element (e.g., third element).

In this disclosure, the term “user” may refer to a person using an electronic device or a device (e.g., artificial intelligence electronic device) using an electronic device.

Aspects of the disclosure may address at least the above-mentioned problems and/or disadvantages and provide at least the advantages described below. Accordingly, an aspect of the disclosure may significantly enhance a processing speed of an artificial neural network and enhance energy efficiency as resource consumption is minimized according to effectively utilizing a plurality of processors.

Accordingly, because fast inference and feedback of the artificial neural network is possible, user satisfaction in using electronic devices applied with the embodiments may be increased, and development in various services utilizing artificial intelligence is possible.

In addition to the above, various effects which are understood directly or indirectly through the disclosure may be provided.

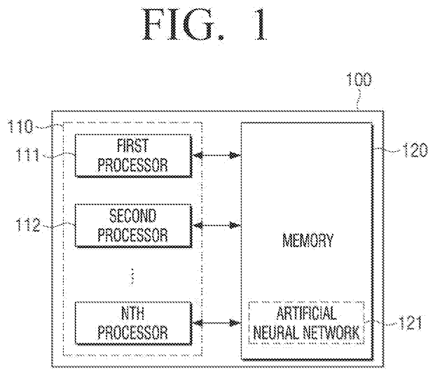

FIG. 1 is a block diagram illustrating a configuration of an electronic device according to an embodiment.

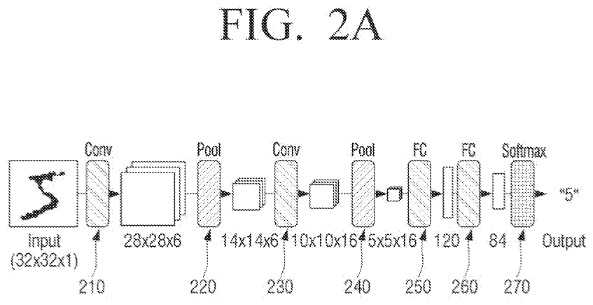

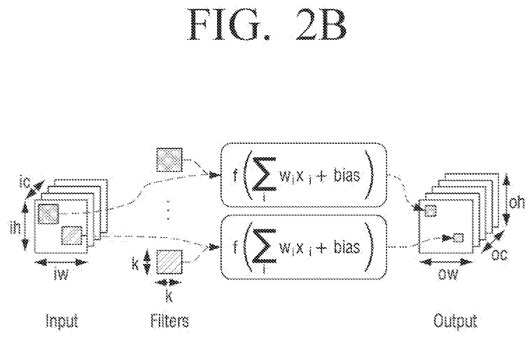

Referring to FIG. 1, the electronic device 100 may include a plurality of processors 110 and a memory 120. The configuration of the electronic device 100 illustrated in FIG. 1 is an example, and various modifications may be made to realize the various embodiments described herein. For example, the electronic device may include a configuration illustrated in FIG. 2, or utilize the configurations to suitably modify the configurations. The various embodiments of the disclosure will be described below based on the electronic device 100.

The electronic device 100 may be a device configured to provide or support an artificial intelligence service. The electronic device 100 may include, as an example, mobile communication devices (e.g., smartphones), computer devices, mobile multimedia devices, medical devices, cameras, wearable devices, digital televisions (TVs), or home appliances, but is not limited to the above-described devices.

The plurality of processors 110 may be configured to execute a computation associated with the control and/or communication of at least one other element or data processing of the electronic device 100. The plurality of processors 110 may be configured to use an artificial neural network 121 (or, artificial neural network model) stored in the memory 120 to obtain a neural network training result on an input value. Alternatively, the plurality of processors 110 may be configured to use the artificial neural network stored in the memory 120 to perform neural network processing on the input value and obtain an output value.

The plurality of processors 110 may be a combination of two or more of a central processing unit (CPU) (e.g., big CPU, little CPU), a graphic processing unit (GPU), an application processor (AP), a Domain-Specific Processors (DSPs), a communication processor (CP), or a neural network processing device (neural processing unit). In this case, two or more of the same type of processors may be used.

According to an embodiment, at least one of the plurality of processors 110 may be configured to obtain a neural network computation plan for performing computation of one neural network layer included in the artificial neural network (e.g., convolution neural network). Based on the obtained neural network computation plan, a first processor 111 may be configured to perform a first portion of the computation of a first neural network layer, and a second processor 112 may be configured to perform a second portion of the computation of the first neural network layer. Further, at least one of the plurality of processors 110 may be configured to use a first output value obtained based on a performance result of the first processor 111 and a second output value obtained based on a performance result of the second processor 112 as input value of a second neural network layer which configures the artificial neural network. At this time, at least one of the plurality of processors 110 may include at least one of the first processor 111 or the second processor 112.

According to an embodiment, at least one of the plurality of processors 110 may be configured to obtain a data type used in the first processor 111 and the second processor 112, respectively. Based on the obtained neural network computation plan and the data type, the first processor 111 may be configured to perform a first portion of the computation of a first neural network layer, and the second processor 112 may be configured to perform a second portion of the computation of the first neural network layer.

According to an embodiment, at least one of the plurality of processors 110 may be configured to obtain the neural network computation plan based on at least one of an execution time of one neural network layer of the respective first processor 111 and second processor 112 or at least one of available resources of the respective first processor 111 and second processor 112.

According to an embodiment, at least one of the plurality of processors 110 may be configured to obtain the neural network computation plan based on at least one of a size of the input value, a size of a filter, a number of the filters, or a size of the output value of the artificial neural network as a structure of the of the artificial neural network.

According to an embodiment, the first processor 111 may be configured to perform a first portion of the computation of a first neural network layer targeting a first input channel, and the second processor 112 may be configured to perform a second portion of the computation of the first neural network layer targeting a second input channel different from the first input channel. At this time, the first neural network layer may be a convolution layer or a fully-connected layer.

According to an embodiment, the first processor 111 may be configured to perform a first portion of the computation of a first neural network layer targeting a first output channel, and the second processor 112 may be configured to perform a second portion of the computation of the first neural network layer targeting a second output channel different from the first output channel. At this time, the first neural network layer may be a pooling layer.

The memory 120 may be configured to store various software programs (or, applications) for operating the electronic device 100, and data and instructions for the operation of the electronic device 100. At least a portion of the program may be downloaded from an external server through a wireless or wired communication. The memory 120 may be accessed by at least one of the plurality of processors 110, and at least one of the plurality of processors 110 may be configured to perform reading/writing/modifying/deleting/updating and the like of the software program, data and instructions included in the memory 120.

The memory 120 may be configured to store the artificial neural network 121 (or an artificial neural network model). In addition, the memory 120 may be configured to store a computation result of the artificial neural network or an output value which is a test result of the artificial neural network. The artificial neural network may include a plurality of layers, and artificial neurons included in the respective layers may include weight and may be coupled with one another. Respective neurons may obtain an output value by multiplying weight and applying a function to the input value, and may transmit the output value to other neurons.

The artificial neural network may be trained to adjust the weight to enhance accuracy in inference. As an example, training the neural network may be a process for optimizing features (e.g., weight, bias, etc.) of respective neurons in a direction of minimizing a cost function of a whole neural network by using a significant amount of learning data. The neural network training may be performed through a feed-forward process and a backpropagation process. As an example, the electronic device 100 may be configured to calculate in stages an input and output of all neurons until a final output layer through the feed-forward process. In addition, the electronic device 100 may be configured to calculate in stages an error in the final output layer by using the backpropagation process. The electronic device 100 may be configured to estimate the features of respective hidden layers by using calculated error values. That is, the neural network training may be a process of obtaining an optimal parameter (e.g., weight or bias) by using the feed-forward process and the backpropagation process.

According to an embodiment, the memory 120 may include a layer partitioning database which includes a processing time of the artificial neural network for the respective processors 110, or a processing time on the respective neural network layers which configure the artificial neural network for the respective processors 110. In addition, the memory 120 may include a data type of the respective processors 110 which are suitable to processing the artificial neural network.

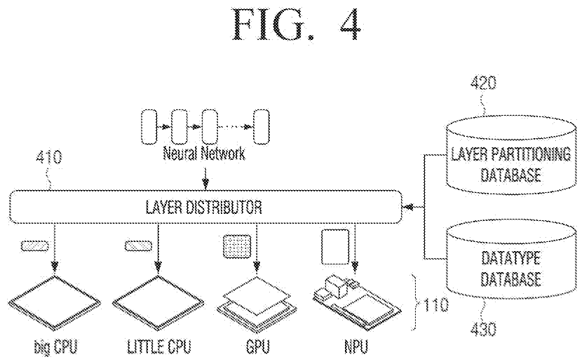

According to an embodiment, the memory 120 may be configured to store a processing result of a layer distributor (410 in FIG. 4) which will be described below. As an example, the memory 120 may be configured to store at least one of a ratio of computation between the plurality of processors 110, or a computational amount of the respective processors 110.

The plurality of processors 110 and the memory 120 which are respective elements of FIG. 1 may be coupled with a bus. The bus may include, for example, circuitry configured to connect elements with one another, and transmit communication (e.g., control message and/or data) between the elements.

FIGS. 2A and 2B are diagrams illustrating a structure of a convolutional neural network according to an embodiment.

The disclosure describes utilizing a CNN, which is widely used in mobile services from among the artificial neural networks, but the embodiments of the disclosure may utilize other neural networks which are not CNNs as will be understood by those skilled in the art from the disclosure herein.

The CNN of FIG. 2A may include a plurality of layers configured to perform another operation with respect to the provided input value. In this case, intermediate output values may in general be values of 3-dimensional neurons (e.g., channel, height, width), and the plurality of layers may in general be distinguished to three types. As an example, the plurality of layers may include convolution layers 210 and 230, pooling layers 220 and 240, fully-connected layers 250 and 260, and a softmax layer 270, but a portion of the layers may be added or omitted according to an implementation method.

The convolution layers 210 and 230 may be a set of result values of performing a convolution computation with respect to the input values.

FIG. 2B is a diagram illustrating an example of a computation of a convolution layer according to an embodiment.

In FIG. 2B, based on the convolution layer accommodating is input channels, a filter may be applied to respective local input values of k×k size, and a dot product between the filter and the local input values may be calculated. The above may be performed taking into consideration the height and width of the input value with respect to all input channels. The convolution layer may be configured to bias and accumulate the dot product result, and obtain oc output channels by applying an activation function (e.g., rectified linear unit (ReLU)) to the accumulated value.

The pooling layers 220 and 240 may be configured to reduce a spatial dimension by applying a global function (e.g., max, average) to local input values. As an example of pooling to reduce the spatial dimension, a maximum pooling may obtain a maximum value of the local input values.

The convolutional neural network may be configured to extract features values (or a feature map) capable of better representing input data through the convolution layers 210 and 230 and the pooling layers 220 and 240.

The fully-connected layers 250 and 260 may be a layer to which a previous layer and the whole neurons are connected. The softmax layer 270 may be a type of an activation function and may be a function capable of including serval classifications.

The convolutional neural network may be configured to calculate a classification result based on the feature value extracted through the fully-connected layers 250 and 260 and the softmax layer 270.

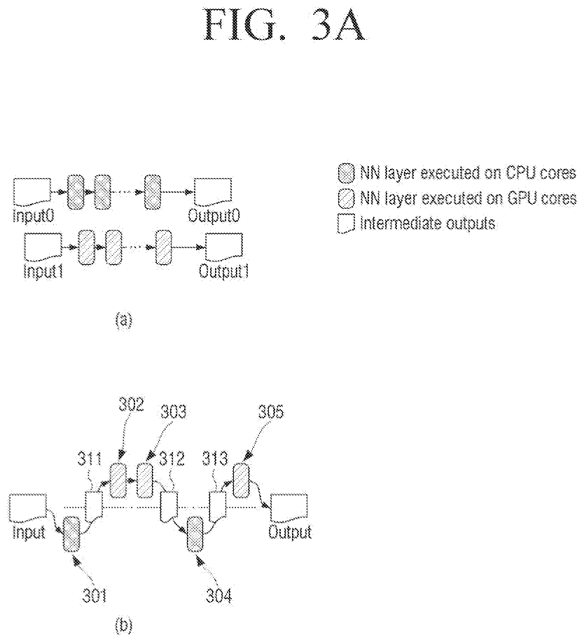

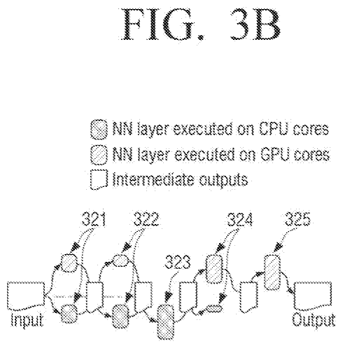

FIGS. 3A and 3B are diagrams illustrating a process of performing an operation of an artificial neural network according to an embodiment.

The respective neural network frameworks in FIGS. 3A and 3B may be configured to use both the first processor (e.g., CPU) and the second processor (e.g., GPU) to improve the processing amount by processing the input values.

First, a first neural network framework of (a) of FIG. 3A may be configured to control all neural network layers in a specific processor to be executed. Based on a plurality of input values being received, the neural network frame work may be configured to disperse the execution of the artificial neural network with respect to respective input values to different processors from one another. As an example, the neural network framework of (a) of FIG. 3A may be configured to use an image classification neural network of the first processor (e.g., CPU) of an upper side with respect to a first input image, and use the image classification neural network of the second processor (e.g., GPU) of a lower side with respect to a second input image.

When using the first processor and the second processor, the processing amount may be improved because the plurality of input values is processed in parallel, and since the respective input values are processed by the respective processors, latency of the whole of the artificial neural network may be determined by the performance of the specific processor.

A second neural network framework of (b) of FIG. 3A may be configured to disperse the execution of a plurality of neural network layers to different processors from one another. As an example, the neural network framework of (b) of FIG. 3A may be configured to use the first processor (e.g., CPU) to execute first and fourth neural network layers 301 and 304, and use the second processor (e.g., GPU) to execute second, third and fifth neural network layers 302, 303 and 305. In this case, intermediate result values 311, 312 and 313 may be generated for sharing between the first processor and the second processor. In addition, because the respective neural network layers are processed in stages by the respective processors, the latency of the whole artificial neural network may be determined by the performance of the specific processor.

In FIG. 3A described above, because the first and second neural network frameworks use the plurality of processors consecutively to execute the neural network layer, the execution performance of the artificial neural network may be limited by the performance of the specific processor.

Accordingly, in order to minimize delay by the performance of the specific processor, the method of processing one neural network layer by concurrently using the first processor (e.g., CPU) and the second processor (e.g., GPU) may be used as with a third neural network framework in FIG. 3B. In this case, the first, second and fourth neural network layers 321, 322 and 324 may be processed concurrently in the first processor and the second processor. In addition, the third and fifth neural network layers 323 and 325 may be executed respectively in the first processor (e.g., CPU) and the second processor (e.g., GPU) as with (b) of FIG. 3A described above. According to an embodiment, the third and fifth neural network layers 323 and 325 may be performed only in any one processors of the first processor (e.g., CPU) and the second processor (e.g., GPU) as with (a) of FIG. 3A described above. A height of a neural network measurement box may represent a calculation amount of the neural network layer of the first and second processors, respectively.

Based on the third neural network framework of FIG. 3B, the processing speed of the artificial neural network may be greatly enhanced. The closer the execution latency and the processing amount of the neural network layer of the respective first processor (e.g., CPU) and second processor (e.g., GPU) are, the third neural network framework may operate more effectively.

FIG. 4 is a diagram illustrating a configuration of a neural network framework for processing an artificial neural network according to an embodiment.

In order to maximize a computation performance of the artificial neural network, it may be desirable to effectively distribute the computational amount of the plurality of processors 110. As an example, the computational amount is distributed targeting the plurality of processors 110 from the perspective of the output channels and a measure of reducing an additional calculation and maximizing performance benefits may be explored. In this case, it may be desirable for the plurality of processors 110 to perform computation on one neural network layer at nearly the same time.

The layer distributor 410 of FIG. 4 may be configured to use the first processor and the second processor to obtain the neural network computation plan for performing computation of one neural network layer which configures (or is included in) the artificial neural network. The layer distributor 410 obtaining the neural network computation plan may include obtaining the neural network computation plan from the memory 120, or obtaining the neural network computation plan from an external device. When the neural network computation plan is obtained from the external device, the layer distributor 410 may be configured to transmit information of the plurality of processors 110 to the external device, and include the obtaining of the neural network computation plan as a response on the transmission. In addition, the layer distributor 410 may be configured to analyze, based on the artificial neural network for processing being provided, a structure of the artificial neural network, and determine and obtain the neural network computation plan on the respective neural network layers which configure the artificial neural network targeting the plurality of available processors 110. The neural network computation plan may include, as an example, at least one of the ratio of computation between the first processor and the second processor, or the computational amount of the respective first processor and second processor.

The layer distributor 410 may be configured to determine a degree of computation of the respective processors 110 to perform computation of one neural network layer based on at least one of the size of the input value of the artificial neural network, the size of the filter, the number of filters or the size of the output value of the artificial neural network as a structure of the artificial neural network. At this time, the layer distributor 410 may be configured to use the plurality of processors 110 to determine the neural network computation plan for performing computation of the respective neural network layers which configure the artificial neural network.

According to an embodiment, the layer distributor 410 may be configured to determine the neural network computation plan taking into consideration the information included in the layer partitioning database 420. The information included in the layer partitioning database 420 may include, as an example, a processing time of the artificial neural network for the respective processors 110, or a processing time on the respective neural network layers which configure the artificial neural network for the respective processors 110. The processing time of the neural network layer of one processor may include, as an example, the processing time of when the processor is assumed to have 100% utilization of the one neural network layer.

In addition, the layer distributor 410 may be configured to determine the neural network computation plan which represents an operation plan of the respective processors 110 on the one neural network layer taking into consideration the processing time on the one neural network layer and available resources of the respective processors 110.

In addition, the layer distributor 410 may be configured to use the predetermined neural network computation plan to determine the neural network computation plan on a new artificial neural network.

In addition, the layer distributor 410 may be configured to use the actual latency of the respective processors 110 which performed computation according to the determined neural network computation plan to determine the neural network computation plan on the artificial neural network.

In addition, the layer distributor 410 may be configured to determine the neural network computation plan suitable to an energy situation of the electronic device 100 taking into consideration a currently available power (e.g., battery capacity) of the electronic device 100 and a power efficiency of the electronic device 100. As an example, the layer distributor 410 may be configured to determine the neural network computation plan so that the electronic device 100 uses minimum power. Specifically, the layer distributor 410 may be configured to analyze the power efficiency of the respective neural network layers which configure the artificial neural network for the respective processors 110 so that minimum power is used in the computation of the artificial neural network. The layer distributor 410 may be configured to establish the neural network computation plan of performing computation of the artificial neural network with minimum power by adjusting, based on the analyzed power efficiency, at least one operating frequency of the plurality of processors 110 performing computation of the neural network layer, or turning off power of at least one of the plurality of processors 110.

Based on the neural network computation plan being determined in the layer distributor 410, the first processor may be configured to perform a portion of the computation of one neural network layer, and the second processor may be configured to perform another portion of the computation of the one neural network layer according to the neural network computation plan. Based on the first output value being obtained according to the performance result of the first processor, and the second output value being obtained according to the performance result of the second processor, the obtained first output value and second output value may be used as input value of another neural network layer.

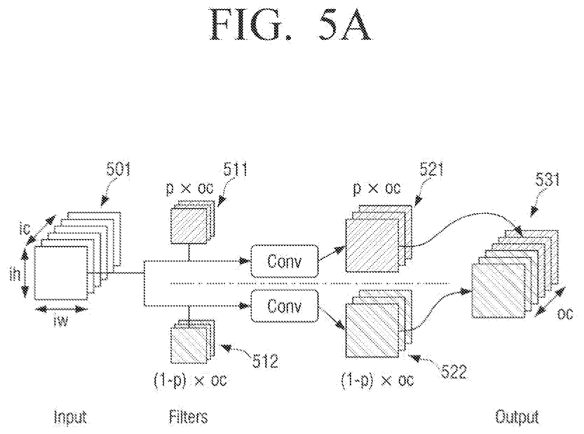

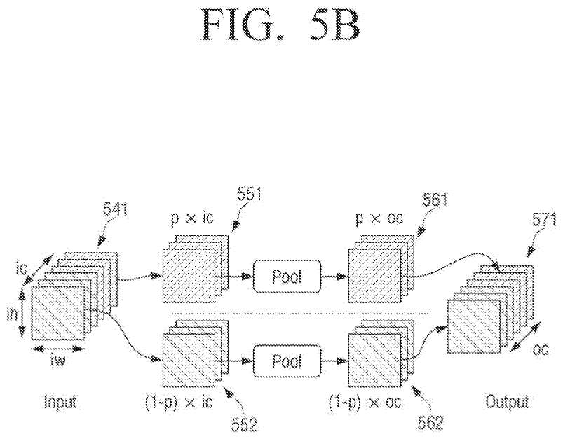

FIGS. 5A and 5B are diagrams illustrating a process of a plurality of processors distributing and performing computations of a neural network layer according to an embodiment. Specifically, FIGS. 5A and 5B are diagrams illustrating a process of the plurality of processors 110 distributing and performing computation of the neural network layer from a channel-wise perspective. In FIGS. 5A and 5B, it may be assumed that the ratio of the computation of the first and second processors may be p:(1−p). FIG. 5A is a diagram illustrating a process of the plurality of processors 110 distributing and performing computation in the convolution layer or the fully-connected layer, and FIG. 5B is a diagram illustrating a process of the plurality of processors 110 distributing and performing computation in the pooling layer.

In the convolution layer or the fully-connected layer of FIG. 5A, the plurality of processors 110 may be configured to distribute and execute computation of the neural network layer based on the output channel. As an example, the filters 511 and 512 which are applied with an input value 501 may be distributed per channel according to the degree of computation of the first and second processors. The respective first and second processors may be configured to use the distributed filters 511 and 512 to generate output values 521 and 522, respectively. The generated respective output values 521 and 522 may be aggregated and a complete output value 531 may be generated. In this case, because the filters are distributed without being overlapped, the overlapping computation between the first and second processors may be minimized.

According to the various embodiments, the artificial neural network may include a long short term memory (LSTM) layer and a gated recurrent unit (GRU) layer of a recurrent neural network (RNN) series. In this case, based on the output channel as in FIG. 5A, the plurality of processors 110 may be configured to distribute and execute computation of the LSTM layer or the GRU layer.

In the pooling layer of FIG. 5B, the plurality of processors 110 may be configured to distribute and execute computation of the neural network layer based on the input channel. As an example, based on the degree of computation of the first and second processors, an input value 541 may be distributed per channel. The respective first and second processors may be configured to apply global function filters 551 and 552 targeting the distributed input value and generate a plurality of output values 561 and 562. The generated respective output values 561 and 562 may be aggregated and a complete output value 571 may be generated. Because the input value is separated and distributed even in this case, overlapping computation between the first and second processors may be minimized.

Referring back to FIG. 4, the layer distributor 410 may be configured to obtain a data type which is to be used by the respective processors by taking into account information included in a data type database 430 to maximize performance of a neural network work frame. Information included in the data type database 430 may include, as an example, data type of the respective processors 110 suited to process the artificial neural network. By taking into consideration the data type for the respective processors 110, the layer distributor 410 may be configured to determine a quantization method suitable to the respective processors 110. At this time, the data type may include, as an example, 16-bit floating-points (F16), quantized 8-bit integers (QUInt8), and the like, but is not limited to the above-described types.

In general, the GPU is configured to use floating points so that it is optimized to a graphic application use, and the CPU may include vector arithmetic logic units (ALUs) capable of processing multiple 8-bit integers per one cycle. In this case, for the conversion of data type, a half-precision floating point method or a linear quantization method may be used as an example. The half-precision floating point method may express 32-bit floating-points as 16-bit floating-points by decreasing an exponent and a mantissa. The linear quantization method may express the 32-bit floating-points as an 8-bit positive integer.

The layer distributor 410 may be configured to store the input value, the filter, and the output value as a linear quantized 8-bit integer value. This may minimize the data transfer size between the CPU, the GPU and the memory.

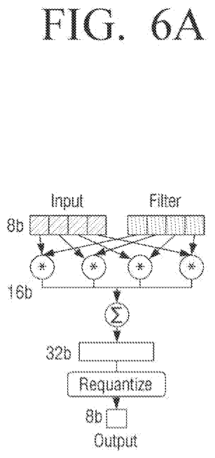

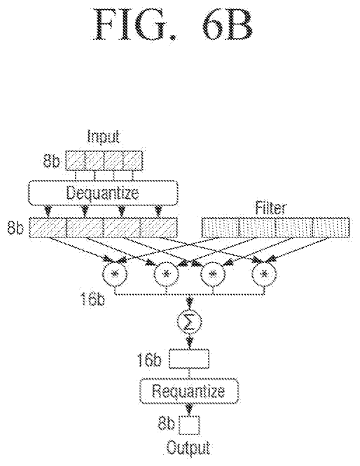

FIGS. 6A and 6B are diagrams illustrating a process of a plurality of processors performing an computation of a neural network layer by using a converted data structure according to an embodiment. In particular, FIGS. 6A and 6B are diagrams illustrating a process of reducing a neural network execution latency according to an application of the two types of the quantization method described above. FIG. 6A is a diagram illustrating an example of performing computation of the neural network layer by converting the data type targeting the CPU, and FIG. 6B is a diagram illustrating an example of performing computation of the neural network layer by converting the data type targeting the GPU.

In FIG. 6A, the CPU may be configured to perform computation of the neural network in 8-bit integer for the sufficient use of the vector ALUs. If a 32-bit value is generated according to the accumulation of convolution computation with an 8-bit input value and the filter in the CPU, a 32-bit output value may be converted to an 8-bit integer value going through a pre-defined quantization process.

In FIG. 6B, the GPU may be configured to perform computation of the neural network in 16-bit floating-points to minimize the operation latency. Accordingly, the 8-bit input value in FIG. 6B may be converted to a 16-bit value through de-quantization, and based on the 16-bit value being generated according to the accumulation of convolution computation of the 16-bit input value and the filter, the 16-bit output value may be converted to the 8-bit integer value going through the pre-defined quantization process.

As described above, based on designating the data type to be used by the respective processors, the operation latency of the neural network layer may be minimized, and consumption of resources necessary in transferring data between the CPU, the GPU and the memory may be minimized.

The recent computation of the artificial neural network may be performed in a method of branching the same input value according to several sequences and processing. The above may be used in a situation in which there is a high possibility of overfitting occurring because the input value is large or the number of neural network layers is significant. A branch computation may be performed in a method of performing convolution computation by using different filter sizes, or obtaining a final output value by connecting the computation result based on the order of the output channel after performing a pooling computation in parallel with respect to the same input value. The processing of the artificial neural network in the branch computation method may include, as an example, GoogLeNet, SqueezeNet module, and the like.

The embodiments of the disclosure may be applied to the processing of the artificial neural network in the branch computation method described above to further reduce execution latency. As an example, the layer distributor 410 may be configured to distribute the computation per processor so as to correspond to the branch. Specifically, the layer distributor 410 may be configured to identify a parallelizable branch set, and allocate the identified respective branch sets to the first processor and the second processor. Accordingly, performing the branch computation targeting the artificial neural network by the first and second processors may be possible.

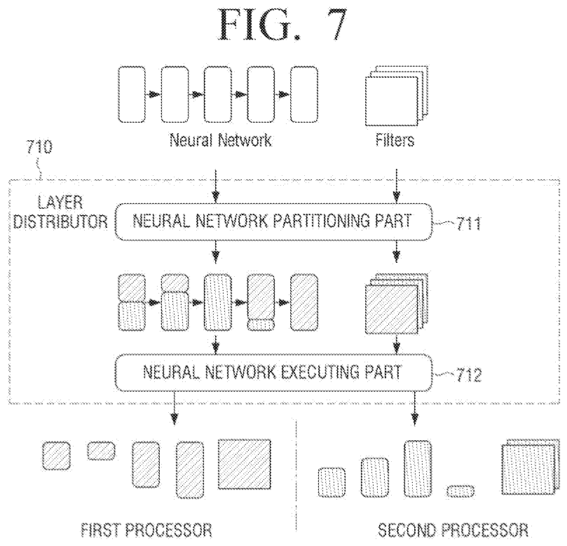

FIG. 7 is a diagram illustrating in detail a layer distributor of the neural network framework in FIG. 4 according to an embodiment.

In FIG. 7, a layer distributor 710 may correspond to the layer distributor 410 of FIG. 4. The layer distributor 710 may be a software layer for an artificial neural network framework performing at least one of a computation distribution method of the above-described channel-wise based neural network layer, the quantization method suitable for respective processors, or the computation distribution method corresponding to the branch.

The layer distributor 710 may be configured to analyze the artificial neural network and the filter, and apply the above methods to the computation of the artificial neural network.

The layer distributor 710 may include a neural network partitioning part 711 and a neural network executing part 712. The neural network partitioning part 711 may be configured to obtain the neural network computation plan which executes cooperation between the processors. As an example, the neural network partitioning part 711 may be configured to determine the optimal distribution ratio for the respective processors to execute the computation distribution method of the above-described channel-wise based neural network layer. As an example, the neural network partitioning part 711 may be configured to predict the latency for the respective processors by taking into consideration a parameter (e.g., filter size, count, etc.) of the neural network layer and the available resources of the respective processors, and determine the optimal distribution ratio for the respective processors taking into consideration the above. In order to predict the latency for the respective processors, a logistic regression algorithm may be used as an example.

The neural network executing part 712 may be configured to execute the artificial neural network based on the neural network computation plan. First, the neural network executing part 712 may be configured to upload the filters to the memory of the first and second processors. Based on the filters being uploaded, the neural network partitioning part 711 may be configured to de-quantize the value of the filters to 16-bit floating-points. Then, the neural network executing part 712 may be configured to execute an application programming interface (API) function (e.g., an OpenCL command for executing the GPU, etc.) of a middle ware to perform the computation of the layer in the optimal distribution ratio.

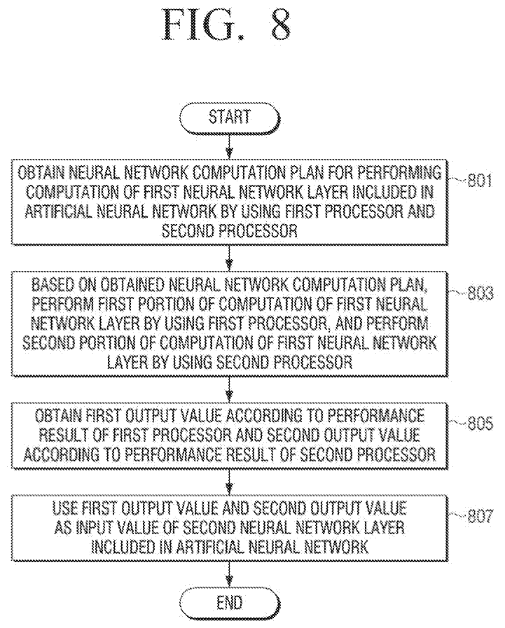

FIG. 8 is a flowchart illustrating an electronic device processing an artificial neural network according to an embodiment.

First, in operation 801, the electronic device 100 may be configured to use the first processor 111 and the second processor 112 to obtain the neural network computation plan for performing computation of one neural network layer included in the artificial neural network. At this time, the neural network computation plan may include at least one of the computation ratio between the first processor 111 and the second processor 112, or the computational amount of the respective first processor 111 and second processor 112.

According to an embodiment, the electronic device 100 may be configured to obtain the neural network computation plan based on at least one of the processing time of the one neural network layer of the respective first processor 111 and second processor 112 or the available resources of the respective first processor 111 and second processor 112.

According to an embodiment, the electronic device 100 may be configured to obtain, as a structure of the artificial neural network, the neural network computation plan based on at least one of the size of the input value, the size of the filter, the number of filters or the size of the output value of the artificial neural network.

According to an embodiment, the electronic device 100 may be configured to use the first processor 111 and the second processor 112 to obtain the neural network computation plan for performing computation of the respective neural network layers which configure the artificial neural network.

In operation 803, the electronic device 100 may be configured to use the first processor 111 to perform a first portion of the computation of the first neural network layer, and use the second processor 112 to perform a second portion of the computation of the first neural network layer according to the obtained neural network computation plan.

According to an embodiment, the electronic device 100 may be configured to obtain the data type used in the respective first processor 111 and second processor 112. Then, based on the obtained neural network computation plan and the data type, the first portion of the computation of the first neural network layer may be performed by using the first processor 111, and the second portion of the computation of the first neural network layer may be performed by using the second processor 112.

According to an embodiment, the electronic device 100 may be configured to use the first processor 111 targeting the first input channel to perform the first portion of the computation of the first neural network, and use the second processor 112 targeting the second input channel which is different from the first input channel to perform the second portion of the computation of the first neural network layer. At this time, the first neural network layer may be the convolution layer or the fully-connected layer.

According to an embodiment, the electronic device 100 may be configured to use the first processor 111 targeting the first output channel to perform the first portion of the computation of the first neural network, and use the second processor 112 targeting the second output channel which is different from the first output channel to perform the second portion of the computation of the one neural network layer. At this time, the first neural network layer may be the pooling layer.

In operation 805, the electronic device 100 may be configured to obtain the first output value based on the performance result of the first processor, and the second output value based on the performance result of the second processor.

In operation 807, the electronic device 100 may be configured to use the obtained first output value and second output value as the input value of a second neural network layer included in the artificial neural network.

In accordance with the disclosure, based on performing a cooperative computation on the respective layers which configure the artificial neural network by using the plurality of processors, the processing time of the artificial neural network may be significantly improved compared to related art. As an example, according to an embodiment, the processing time and power consumption of image classification neural networks (e.g., GoogLeNet, SqueezeNet, VGG-16, AlexNet, MobileNet) may be significantly improved compared to the related art which uses a single processor.

Based on applying an embodiment of the disclosure to a Galaxy Note 5, it may be verified that the processing time is reduced by an average of 59.9% compared to the related art, and the energy consumed is reduced by an average of 26% compared to the related art. In addition, based on applying an embodiment to a Galaxy A5, it may be verified that the processing time is reduced by an average of 69.6% compared to the related art, and the energy consumed is reduced by an average of 34% compared to the related art.

As described above, reduction in processing time and reduction in energy consumption of the artificial neural network may significantly contribute to the efficient operation of the artificial neural network and diversification in the application field.

The term “module” used in the disclosure may include a unit configured as a hardware, software, or firmware, and may be used interchangeably with terms such as, for example, and without limitation, logic, logic blocks, components, circuits, or the like. “Module” may be a component integrally formed or a minimum unit or a part of the component performing one or more functions. According to an embodiment, a module may be realized in the form of an application-specific integrated circuit (ASIC).

The various embodiments may be implemented with software including one or more instructions stored in a machine (e.g., electronic device 100) readable storage media (e.g., memory 120). For example, a processor (e.g., at least one of a plurality of processors 110) of the machine (e.g., electronic device 100) may call at least one instruction of the stored one or more instructions from the storage medium, and execute the at least one instruction. This makes it possible for the machine to be operated to perform at least one function according to the called at least one instruction. The one or more instructions may include a code generated by a compiler or executed by an interpreter. The machine-readable storage medium may be provided in the form of a non-transitory storage medium. Herein, ‘non-transitory’ merely means that the storage medium is a tangible device, and does not include a signal (e.g., electromagnetic waves), and the term does not differentiate data being semi-permanently stored or being temporarily stored in the storage medium.

According to an embodiment, a method according to the various embodiments may be provided included a computer program product. The computer program product may be exchanged between a seller and a purchaser as a commodity. The computer program product may be distributed in the form of a machine-readable storage medium (e.g., a compact disc read only memory (CD-ROM)), or distributed online (e.g., download or upload) through an application store (e.g., PLAYSTORE™) or directly between two user devices (e.g., smartphones). In the case of online distribution, at least a portion of the computer program product may be at least stored temporarily in a storage medium readable by a machine such as a server of a manufacturer, a server of an application store, or a memory of a relay server, or temporarily generated.

According to the various embodiments, respective elements (e.g., a module or a program) of the above-described elements may include of a single entity or a plurality of entities. According to the various embodiments, one or more elements of the above-described corresponding elements or operations may be omitted, or one or more other elements or operations may be further included. Alternatively or additionally, a plurality of elements (e.g., modules or programs) may be integrated into one entity. In this case, the integrated element may be configured to perform one or more functions of an element of the respective elements the same or similarly with the function performed by the corresponding element of the plurality of elements prior to integration. According to the various embodiments, operations performed by a module, a program, or another element may be performed sequentially, in a parallel, repetitively, or in a heuristically manner, or one or more of the operations may be performed in a different order, omitted or one or more different operations may be added.

While embodiments have been described with reference to the drawings, it will be understood by those of ordinary skill in the art that various changes in form and details may be made therein without departing from the spirit and scope as defined by the following claims.

What is claimed is:

1. A method for processing an artificial neural network by an electronic device, the method comprising:
obtaining, by using a first processor and a second processor, a neural network computation plan for performing computation of a first neural network layer of the artificial neural network;
performing a first portion of the computation of the first neural network layer by using the first processor, and performing a second portion of the computation of the first neural network layer by using the second processor, based on the neural network computation plan;
obtaining a first output value based on a performance result of the first processor and a second output value based on a performance result of the second processor; and
using the first output value and the second output value as an input value of a second neural network layer of the artificial neural network.

2. The method of claim 1, wherein the neural network computation plan comprises at least one of a computation ratio between the first processor and the second processor, or a computational amount of the first processor and a computational amount of the second processor.

3. The method of claim 1, further comprising:
obtaining a data type used in the respective first processor and second processor,
wherein the performing the first portion of the computation of the first neural network layer by using the first processor, and the performing the second portion of the computation of the first neural network layer by using the second processor is performed based on the obtained neural network computation plan comprises performing the first portion of the computation of the first neural network layer by using the first processor, and performing the second portion of the computation of the first neural network layer by using the second processor, based on the obtained neural network computation plan and the data type.

4. The method of claim 1, wherein the obtaining the neural network computation plan comprises obtaining the neural network computation plan based on at least one of a processing time of the first neural network layer of the respective first processor and second processor or available resources of the respective first processor and second processor.

5. The method of claim 1, wherein the obtaining the neural network computation plan comprises obtaining the neural network computation plan based on at least one of a size of an input value, a size of a filter, a number of filters or a size of an output value of the artificial neural network as a structure of the artificial neural network.

6. The method of claim 1, wherein the performing the first portion of the computation of the first neural network layer by using the first processor comprises targeting a first input channel, and the performing the second portion of the computation of the first neural network layer by using the second processor comprises targeting a second input channel different from the first input channel.

7. The method of claim 6, wherein the first neural network layer is a convolution layer, a fully-connected layer, a long short term memory (LSTM) layer, or a gated recurrent unit (GRU) layer LSTM layer.

8. The method of claim 1, wherein the performing the first portion of the computation of the first neural network layer by using the first processor comprises targeting a first output channel, and the performing the second portion of the computation of the first neural network layer by using the second processor comprises targeting a second output channel different from the first output channel.

9. The method of claim 8, wherein the first neural network layer is a pooling layer.

10. The method of claim 1, wherein the obtaining the neural network computation plan comprises obtaining the neural network computation plan for performing computation of a plurality of neural network layers of the artificial neural network by using the first processor and the second processor.

11. An electronic device configured to process an artificial neural network, the electronic device comprising:
a memory configured to store instructions; and
a plurality of processors configured to execute the instructions and comprising a first processor and a second processor,
wherein at least one of the plurality of processors is configured to obtain a neural network computation plan for performing computation of a first neural network layer of the artificial neural network,
wherein the first processor is configured to perform a first portion of the computation of the first neural network layer, and the second processor is configured to perform a second portion of the computation of the first neural network layer, based on the neural network computation plan, and
wherein the at least one of the plurality of processors is further configured to use a first output value obtained based on a performance result of the first processor and a second output value obtained based on a performance result of the second processor as an input value of a second neural network layer of the artificial neural network.

12. The electronic device of claim 11, wherein the neural network computation plan comprises at least one of a computation ratio between the first processor and the second processor, or a computational amount of the first processor and a computational amount of the second processor, respectively.

13. The electronic device of claim 11, wherein the at least one of the plurality of processors is further configured to obtain a data type used in the respective first processor and second processor, and
wherein the first processor is further configured to perform the first portion of the computation of the first neural network layer, and the second processor is further configured to perform the second portion of the computation of the first neural network layer, based on the obtained neural network computation plan and the data type.

14. The electronic device of claim 11, wherein the at least one of the plurality of processors is further configured to obtain the neural network computation plan based on at least one of an execution time of the first neural network layer of the respective first processor and the second processor or available resources of the respective first processor and the second processor.

15. The electronic device of claim 11, wherein the at least one of the plurality of processors is further configured to obtain the neural network computation plan based on at least one of a size of an input value, a size of a filter, a number of filters, or a size of an output value of the artificial neural network as a structure of the artificial neural network.
